(19) United States
(12) Patent Application Publication
(10) Pub. No.: US 2026/0235787 A1
(43) Pub. Date: Aug. 13, 2026

(54) OPTICAL SYSTEM AND IMAGE PICKUP APPARATUS

(71) Applicant: CANON KABUSHIKI KAISHA, Tokyo (JP)

(72) Inventor: Yuuki MAEDA, Tochigi (JP)

(73) Assignee: CANON KABUSHIKI KAISHA, Tokyo (JP)

(21) Appl. No.: 19/463,382

(22) Filed: Jan. 29, 2026

(30) Foreign Application Priority Data
Feb. 12, 2025 (JP) 2025-020512

(51) Int. Cl. G02B 1/04; G02B 9/10

(52) U.S. Cl. CPC G02B 1/041; G02B 9/10

(57) ABSTRACT

An optical system includes a lens A, and an optical filter made from resin. A predetermined inequality is satisfied.

### BACKGROUND

### Field of the Technology

The present disclosure relates to one or more embodiments of an optical system and an image pickup apparatus.

### Description of the Related Art

Conventionally, optical systems having optical filters are known.

### SUMMARY

An optical system according to one aspect of the present disclosure may include a lens A, and an optical filter made from resin. The following inequality is satisfied:

nA=(n2+n3)/2

0.000≤|n1−nA|≤0.020

where n1 is a refractive index of the optical filter for d-line in a first direction parallel to an optical axis of the lens A, n2 is a refractive index of the optical filter for the d-line in a second direction orthogonal to the first direction, n3 is a refractive index of the optical filter for the d-line in a third direction orthogonal to both the first direction and the second directions. An image pickup apparatus having the above optical system also constitutes another aspect of the present disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a sectional view of an optical system according to Example 1.

FIG. 2 is an aberration diagram of the optical system according to Example 1.

FIG. 3 is a sectional view of an optical system according to Example 2.

FIG. 4 is an aberration diagram of the optical system according to Example 2.

FIG. 5 is a sectional view of an optical system according to Example 3.

FIG. 6 is an aberration diagram of the optical system according to Example 3.

FIG. 7 is a sectional view of an optical system according to Example 4.

FIG. 8 is an aberration diagram of the optical system according to Example 4.

FIG. 9 is a sectional view of an optical system according to Example 5.

FIG. 10 is an aberration diagram of the optical system according to Example 5.

FIG. 11 is a schematic diagram of the image pickup apparatus having any one of the optical systems according to the respective examples.

### DESCRIPTION OF THE EMBODIMENTS

Referring now to the accompanying drawings, a detailed description will be given of embodiments according to the present disclosure. Corresponding elements in respective figures will be designated by the same reference numerals, and a duplicate description thereof will be omitted.

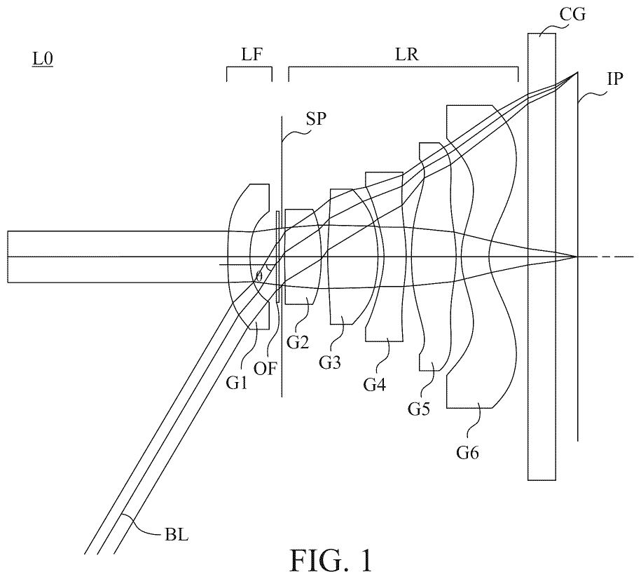

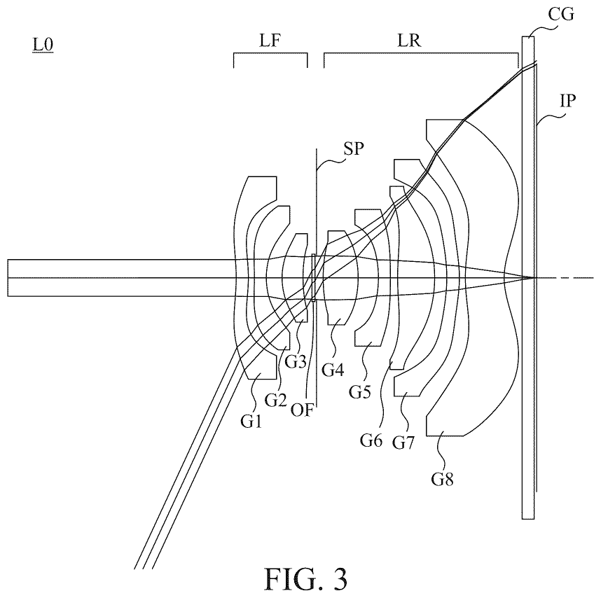

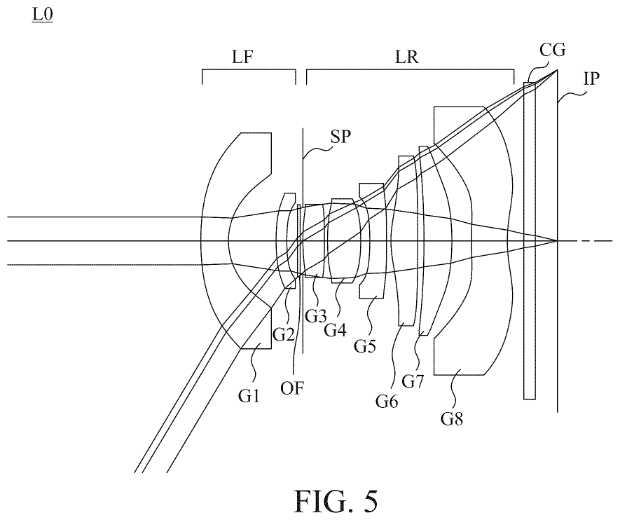

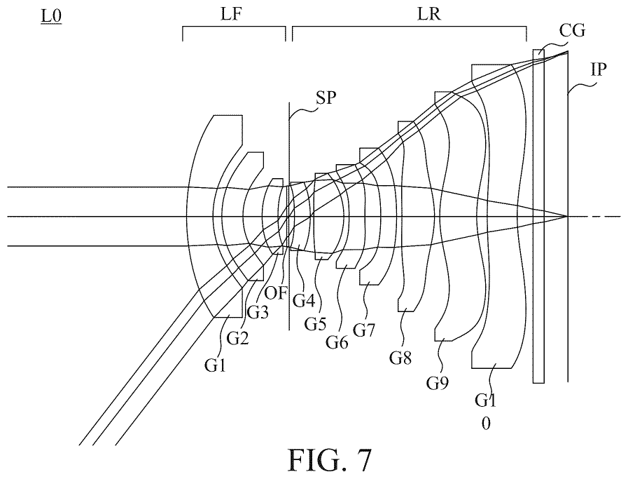

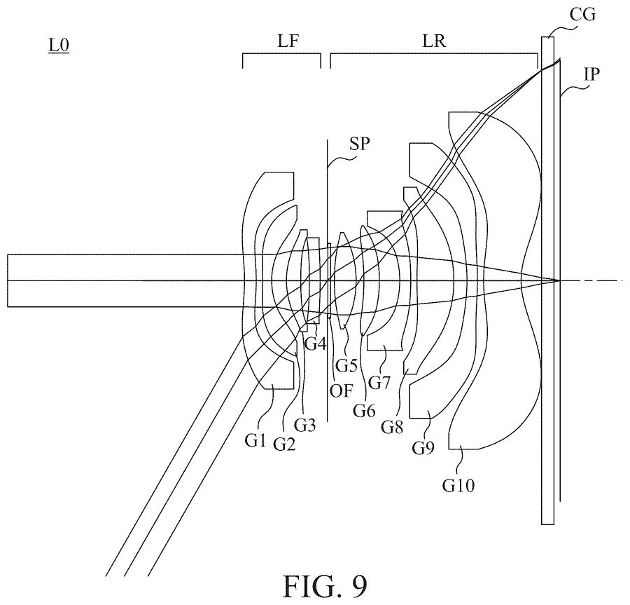

FIGS. 1, 3, 5, 7, and 9 are sectional views of an optical system L0 according to Examples 1 to 5, respectively. The optical system L0 according to each example is used in image pickup apparatus such as digital video cameras, digital still cameras, broadcasting cameras, film-based cameras, surveillance cameras, and on-board cameras (in-vehicle cameras).

In each sectional view, the left is the object side and the right is the image side. In a case where the optical system L0 according to each example is used as a projection lens for a projector, the left is the screen side and the right is the projected image side.

The optical system L0 according to each example includes a plurality of lens units. In each example, a lens unit is a group of lenses separated by an aperture stop SP that determines an on-axis light ray. Each of the optical systems L0 according to Examples 1 to 4 includes, in order from the object side to the image side, a front group (first lens unit) LF, an optical filter (light amount adjusting filter) OF, an aperture stop SP, and a rear group (second lens unit) LR. The optical system L0 according to Example 5 includes, in order from the object side to the image side, a front group (first lens unit) LF, an aperture stop SP, an optical filter (light amount adjusting filter) OF, and a rear group (second lens unit) LR.

The front group LF is a group of all lenses disposed on the object side of the aperture stop SP (or disposed closer to the object than the aperture stop SP). The rear group LR is a group of all lenses disposed on the image side of the aperture stop SP (or disposed closer to the image plane than the aperture stop SP). Each lens unit may consist of one or more lenses. The lens unit may include optical elements such as aspherical lenses that have no paraxial refractive power (those with an infinity paraxial radius of curvature), Fresnel lenses, or diffractive optical elements.

In each sectional view, Gi indicates an i-th lens (where i is a natural number) counted from the object side. IP represents an image plane, on which an imaging surface of an image sensor (photoelectric conversion element) such as a CCD sensor or CMOS sensor is disposed in a case where the optical system L0 according to each example is used as an imaging optical system for a digital still camera or digital video camera. In a case where the optical system L0 according to each example is used as an imaging optical system of a film-based camera, a photosensitive surface corresponding to the film surface is disposed on the image plane IP. CG represents a cover glass. The cover glass CG is not included in the term “lens.”

The optical system L0 according to each example includes at least one resin lens (a lens made from resin). All of the lenses constituting the optical system L0 may be resin lenses. While the optical system L0 according to each example includes an aperture stop SP, the present disclosure is not limited to this embodiment and is applicable to optical systems that have no aperture stop SP.

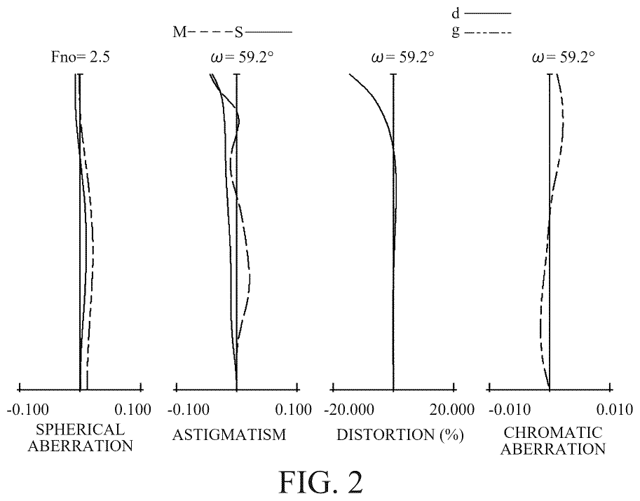

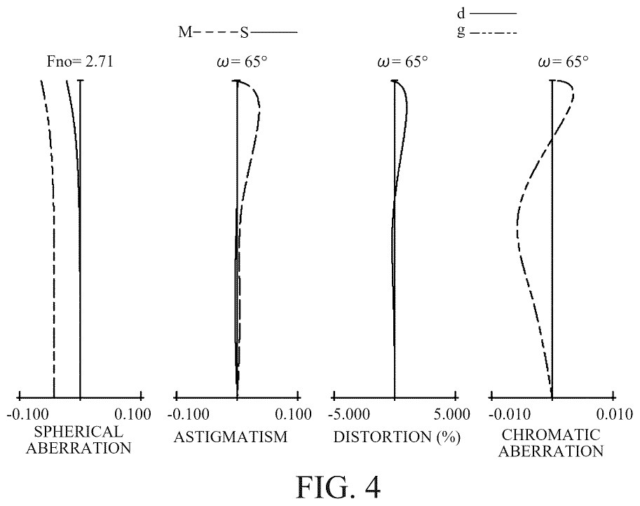

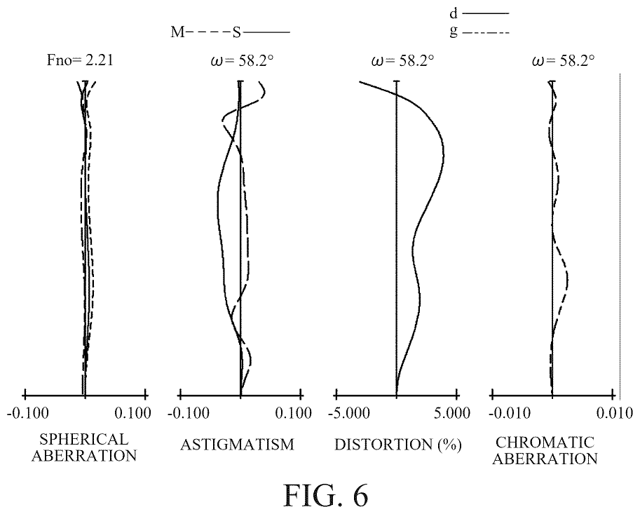

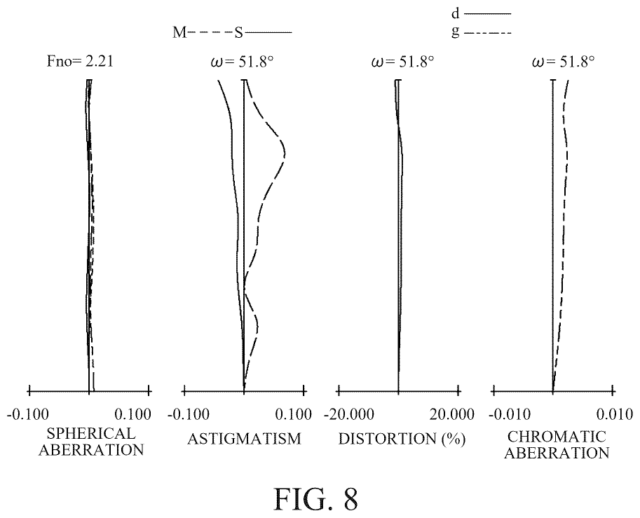

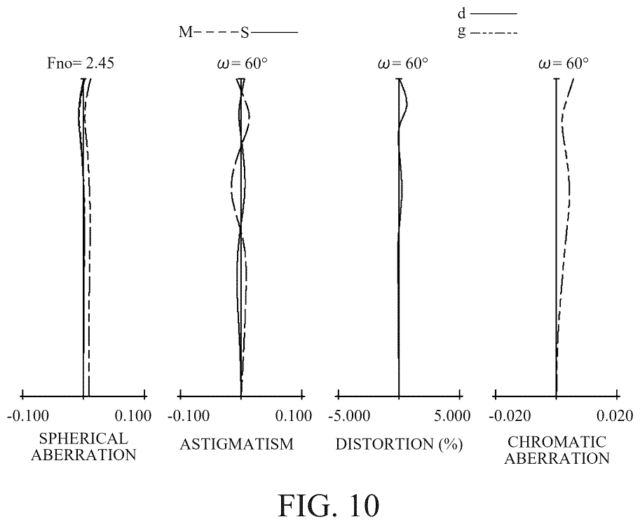

FIGS. 2, 4, 6, 8, and 10 are aberration diagrams for the optical systems L0 according to Examples 1 to 5, respectively. In the spherical aberration diagram, Fno is an F-number. The spherical aberration diagram illustrates spherical aberration amounts for the d-line (wavelength 587.6 nm) and g-line (wavelength 435.8 nm). In the astigmatism diagram, S represents an astigmatism amount in a sagittal image plane, and M represents an astigmatism amount in a meridional image plane. The distortion diagram illustrates a distortion amount for the d-line. The chromatic aberration diagram illustrates a lateral chromatic aberration amount for the g-line. ω is a half angle of view (°).

A description will now be given of the configuration for the optical system L0 according to each example.

The optical system L0 according to each example includes a lens and a resin optical filter OF. Now, assume that a direction parallel to the optical axis of the lens is a first direction (Z direction), a direction orthogonal to the first direction is a second direction (X direction), and a direction orthogonal to both the first and second directions is a third direction (Y direction). Let n1 be a refractive index of the optical filter OF for the d-line in the first direction, let n2 be a refractive index of the optical filter OF for the d-line in the second direction, and let n3 be a refractive index of the optical filter OF for the d-line in the third direction. Then, the following inequality (1) may be satisfied:

$$n A = ( n 2 + n 3 ) / 2 \qquad ( 1 )$$

$$0. \leq \vert n 1 - n A \vert \leq 0.02$$

In a case where |n1−nA| becomes higher than the upper limit of inequality (1), it causes light rays to separate, resulting in a degradation of image quality.

The upper limit of inequality (1) may be set to 0.019, 0.018, 0.017, 0.016, 0.015, 0.014, 0.013, 0.012, 0.011, or 0.010.

In each example, the following inequality (2) may be satisfied:

$$15 \leq θ < 90 \qquad ( 2 )$$

where θ (°) is an angle at which the principal ray of the outermost off-axis light (light ray BL passing through the center of the aperture stop SP) of the optical system L0 is incident on the optical filter OF (an angle between the principal ray of the outermost off-axis light and the optical axis).

In a case where θ becomes lower than the lower limit of inequality (2), image quality is unlikely to deteriorate, even without considering the refractive index.

The lower limit of inequality (2) may be set to 20, 25, 30, 35, 40, 45, or 50.

In each example, the following inequality (3) may be satisfied:

$$0. < d \leq 0.100 \qquad ( 3 )$$

where d (mm) is a thickness of the optical filter OF (thickness on the optical axis in the optical axis direction).

In a case where d is higher than the upper limit of inequality (3), the thickness of the optical filter OF increases, the size of the optical system L0 increases, or the amount of light beam separation increases, resulting in image quality degradation.

The upper limit of inequality (3) may be set to 0.095, 0.090, 0.085, 0.080, 0.075, 0.070, 0.065, 0.060, or 0.055.

In each example, the following inequality (4) may be satisfied:

$$0. \leq d \times \vert n 1 - n A \vert \times sin θ \leq 0.001 \qquad ( 4 )$$

In a case where dx|n1−nA|×sin θ is higher than the upper limit of inequality (4), the amount of light beam separation increases according to the angle θ and the thickness d.

The upper limit of inequality (4) may be set to 0.0009, 0.0008, 0.0007, 0.0006, 0.0005, or 0.0004.

In each example, the following inequalities (5) and (6) may be satisfied:

$$0. \leq \vert n 1 - n 2 \vert \leq 0.016 \qquad ( 5 )$$

$$0. \leq \vert n 1 - n 3 \vert \leq 0.016 \qquad ( 6 )$$

In a case where |n1−n2| becomes higher than the upper limit of inequality (5) or |n1−n3| becomes higher than inequality (6), the image quality deteriorates.

The upper limit of inequality (5) may be set to 0.015, 0.014, 0.013, 0.012, 0.011, 0.010, or 0.009. The upper limit of inequality (6) may be set to 0.015, 0.014, 0.013, 0.012, or 0.011.

In each example, the following inequality (7) may be satisfied:

$$1.4 \leq n 1 \leq 1.7 \qquad ( 7 )$$

If inequality (7) is not satisfied, it is difficult to select a plastic optical filter.

The lower limit of inequality (7) may be set to 1.41, 1.42, 1.43, or 1.44. The upper limit of inequality (7) may be set to 1.69, 1.68, 1.67, 1.66, 1.65, 1.64, 1.63, 1.62, or 1.61.

In each example, the optical system L0 may include a plastic lens. The lens closest to the object among the plurality of lenses in the optical system L0 may be a plastic lens. The lens disposed on the object side of the optical filter OF (the lens adjacent to the optical filter OF) may be a plastic lens. The lens disposed on the image side of the optical filter OF (the lens adjacent to the optical filter OF) may be a plastic lens with positive refractive power.

In each example, the following inequality (8) may be satisfied:

$$0. < S / f \leq 1. \qquad ( 8 )$$

where f is the focal length of the optical system L0 and S is the distance in the optical axis direction between the optical filter OF and the aperture stop SP.

In a case where S/f becomes higher than the upper limit of inequality (8), the sizes of the optical filter OF and the optical system L0 increase.

The upper limit of inequality (8) may be set to 0.9, 0.8, 0.7, 0.6, 0.5, 0.4, 0.3, 0.2, or 0.1.

In each example, an object-side lens surface of the final lens closest to the image plane in the optical system L0 may have a stationary point (inflection point) and is convex near the optical axis and concave on the periphery (undulating aspherical surface). In each example, an image-side lens surface of the final lens may have a stationary point (inflection point) and be concave near the optical axis and convex on the periphery (undulating aspheric surface).

In Examples 1 to 4, each optical system L0 consists of, in order from the object side to the image side, a front group LF with negative refractive power, an optical filter OF, an aperture stop SP, and a rear group LR with positive refractive power. In Example 5, the optical system L0 consists of, in order from the object side to the image side, a front group LF with negative refractive power, an aperture stop SP, an optical filter OF, and a rear group LR with positive refractive power.

In each example, the following inequality (9) may be satisfied:

$$- 6.00 \leq f l / f < 0.00 \qquad ( 9 )$$

where f1 is a focal length of the front group LF.

In a case where f1/f becomes lower than the lower limit of inequality (9), the negative refractive power of the first lens unit L1 decreases, and the lens thickness deviation ratio reduces to simultaneously correct distortion and curvature of field, resulting in poor formability. On the other hand, in a case where f1/f becomes higher than the upper limit of inequality (9), the first lens unit L1 has positive refractive power, and it becomes difficult to reduce the overall length.

The lower limit of inequality (9) may be set to −5.80, −5.60, −5.40, −5.20, −5.00, −4.80, −4.60, or −4.40. The upper limit of inequality (9) may be set to −0.20, −0.40, −0.60, −0.80, −1.00, −1.20, −1.40, −1.60, or −1.80.

In each example, the following inequality (10) may be satisfied:

$$0.25 \leq ImgH / L \leq 2. \qquad ( 10 )$$

where ImgH is a maximum image height of the optical system L0, and L is an overall length of the optical system L0 (a distance from the lens surface closest to the object in the optical system L0 to the image plane IP).

In other words, the overall length of the optical system L0 is a distance on the optical axis from the lens surface closest to the object in the optical system L0 to the lens surface closest to the image plane (not including optical block FL) plus the back focus. Here, the back focus is a distance on the optical axis from the lens surface closest to the image plane in the optical system L0 to the image plane IP (paraxial image plane), expressed in air-equivalent length.

In a case where inequality (10) is not satisfied, it becomes difficult to reduce the overall length of a compact optical system.

The lower limit of inequality (10) may be set to 0.27, 0.29, 0.31, 0.33, 0.35, 0.37, 0.39, or 0.41. The upper limit of inequality (10) may be set to 1.95, 1.90, 1.85, 1.80, 1.75, 1.70, 1.65, 1.60, 1.55, 1.50, 1.45, or 1.40.

In each example, the following inequality (11) may be satisfied:

$$1.55 \leq n f \leq 1.9 \qquad ( 11 )$$

where nf is a refractive index for the d-line of the final lens in the optical system L0.

In a case where nf becomes lower than the lower limit of inequality (11), the thickness deviation ratio becomes too high, resulting in excessive correction of curvature of field. On the other hand, in a case where nf becomes higher than the upper limit of inequality (11), the thickness deviation ratio becomes too low, resulting in insufficient correction of curvature of field.

The lower limit of inequality (11) may be set to 1.56, 1.57, 1.58, 1.59, 1.60, 1.61, 1.62, 1.63, 1.64, 1.65, or 1.66. The upper limit of inequality (11) may be set to 1.88, 1.86, 1.84, 1.82, 1.80, 1.78, or 1.76.

In each example, the following inequality (12) may be satisfied:

$$0 < P L \leq 100 \qquad ( 12 )$$

where PL (10⁻¹²/Pa) is a photoelastic coefficient of the optical filter OF.

In a case where PL becomes higher than the upper limit of inequality (12), thermal stress is generated, which causes birefringence proportional to the photoelastic coefficient and changes the refractive index difference.

The lower limit of inequality (12) may be set to 1, 2, 3, 4, or 5. The upper limit of inequality (12) may be set to 96, 92, 88, 84, 80, or 76.

In each example, the following inequality (13) may be satisfied:

$$0 < {}^{TM} \leq 50 \qquad ( 13 )$$

where ^{Tm} (%) is a minimum transmittance within the effective diameter of the optical filter OF.

Applying the configuration according to each example within the range of inequality (13) is particularly effective.

The upper limit value of inequality (13) may be set to 45, 40, 35, or 30.

In each example, the optical filter OF is a blur filter (a filter that reduces transmittance at the periphery) or an ND filter (neutral density filter). In each example, the optical filter OF is made from acrylic resin or polycarbonate.

The optical system L0 according to each example is an optical system that has a lens and an optical filter made from resin, and the object-side lens surface of the lens may have a stationary point and may have a shape that is convex near the optical axis of the lens and concave on the periphery.

Next, the optical system L0 according to each example will be described in detail.

The optical system L0 according to Example 1 includes, in order from the object side to the image side, a front group LF, an optical filter OF, an aperture stop SP, and a rear group LR. The front group LF consists of a first lens G1. The rear group LR consists of, in order from the object side to the image side, a second lens G2, a third lens G3, a fourth lens G4, a fifth lens G5, and a sixth lens G6. The sixth lens G6 is the final lens. The object-side lens surface of the sixth lens G6 has a stationary point and is convex near the optical axis and concave at the periphery. The image-side lens surface of the sixth lens G6 also has a stationary point and is concave near the optical axis and convex at the periphery.

The optical system L0 according to Example 2 consists of, in order from the object side to the image side, a front group LF, an optical filter OF, an aperture stop SP, and a rear group LR. The front group LF consists of, in order from the object side to the image side, a first lens G1, a second lens G2, and a third lens G3. The rear group LR consists of, in order from the object side to the image side, a fourth lens G4, a fifth lens G5, a sixth lens G6, a seventh lens G7, and an eighth lens G8. The eighth lens G8 is the final lens. The object-side lens surface of the eighth lens G8 has a stationary point and is convex near the optical axis and concave at the periphery. The image-side lens surface of the eighth lens G8 has a stationary point and is concave near the optical axis and convex at the periphery.

The optical system L0 according to Example 3 includes, in order from the object side to the image side, a front group LF, an optical filter OF, an aperture stop SP, and a rear group LR. The front group LF consists of, in order from the object side to the image side, a first lens G1 and a second lens G2. The rear group LR consists of, in order from the object side to the image side, a third lens G3, a fourth lens G4, a fifth lens G5, a sixth lens G6, a seventh lens G7, and an eighth lens G8. The eighth lens G8 is the final lens. The object-side lens surface of the eighth lens G8 has a stationary point and is convex near the optical axis and concave at the periphery. The image-side lens surface of the eighth lens G8 has a stationary point and is concave near the optical axis and convex at the periphery.

The optical system L0 according to Example 4 includes, in order from the object side to the image side, a front group LF, an optical filter OF, an aperture stop SP, and a rear group LR. The front group LF consists of, in order from the object side to the image side, a first lens G1, a second lens G2, and a third lens G3. The rear group LR consists of, in order from the object side to the image side, a fourth lens G4, a fifth lens G5, a sixth lens G6, a seventh lens G7, an eighth lens G8, a ninth lens G9, and a tenth lens G10. The tenth lens G10 is the final lens. The object-side lens surface of the tenth lens G10 has a stationary point and is convex near the optical axis and concave at the periphery. The image-side lens surface of the tenth lens G10 has a stationary point and is concave near the optical axis and convex at the periphery.

The optical system L0 according to Example 5 includes, in order from the object side to the image side, a front group LF, an aperture stop SP, an optical filter OF, and a rear group LR. The front group LF consists of, in order from the object side to the image side, a first lens G1, a second lens G2, a third lens G3, and a fourth lens G4. The rear group LR consists of, in order from the object side to the image side, a fifth lens G5, a sixth lens G6, a seventh lens G7, an eighth lens G8, a ninth lens G9, and a tenth lens G10. The tenth lens G10 is the final lens. The object-side lens surface of the tenth lens G10 has a stationary point and is convex near the optical axis and concave at the periphery. The image-side lens surface of the tenth lens G10 also has a stationary point and is concave near the optical axis and convex at the periphery.

Numerical values corresponding to Examples 1 to 5, respectively, will be illustrated below.

In surface data for each numerical example, r represents a radius of curvature of each optical surface, and d (mm) represents an on-axis distance (distance on the optical axis) between m-th and (m+1)-th surface, where m is a surface number counted from the light incident side. nd represents a refractive index of each optical element at the d-line, and vd represents an Abbe number of the optical element. The Abbe number vd of a material is expressed as follows:

$$v d = ( N d - 1 ) / ( NF - NC )$$

where Nd, NF, NC, and Ng are refractive indices of d-line (587.6 nm), F-line (486.1 nm), C-line (656.3 nm), and g-line (wavelength 435.8 nm) in the Fraunhofer line.

If the optical surface is aspherical, an asterisk * is added to the right of the radius of curvature r. The aspherical shape is expressed by the following equation:

$$x = ( {h}^{2} / R ) / [ 1 + {\{ 1 ( 1 + k ) {( h / R )}^{2} \}}^{1 / 2} ] + C 2 {h}^{2} + C 4 {h}^{4} + C 6 {h}^{6} + C 8 {h}^{8} + C 10 {h}^{10} + C12 {h}^{12} + C 14 {h}^{14} + C 16 {h}^{16} + C 1 h + C 3 {h}^{3} + C 5 {h}^{5} + C 7 {h}^{7} + C 9 {h}^{9} + C 11 {h}^{11} + C 13 {h}^{13} + C 15 {h}^{15} + C18 {h}^{18} + C 20 {h}^{20} + C 22 {h}^{22} + C 24 {h}^{24} + C 17 {h}^{17} + C 19 {h}^{19} + C 21 {h}^{21} + C 23 {h}^{23}$$

where x is a displacement amount from a surface vertex in the optical axis direction, h is a height from the optical axis in a direction orthogonal to the optical axis, R is a paraxial radius of curvature, k is a conic constant, and C1 to C24 are aspherical coefficients of each order.

“e±XX” in each aspheric coefficient means “×10^{±XX}.”

### Numerical Example 1

UNIT: mm
SURFACE DATA

| Surface | | | | |
|---|---|---|---|---|
| No. | r | d | nd | νd |
| 1 | 20.42974* | 0.4 | 1.5350 | 56.00 |
| 2 | 2.17417* | 0.475 | 1.0000 | 0.00 |
| 3 | 0 | 0.05 | 1.5000 | 60.00 |
| 4 | 0 | 0.05 | 1.0000 | 0.00 |
| 5p | 0 | 0.05056 | 1.0000 | 0.00 |
| 6 | 14.12749* | 0.66 | 1.5350 | 56.00 |
| 7 | −3.47867* | 0.1161 | 1.0000 | 0.00 |
| 8 | 5.01926* | 0.908 | 1.5350 | 56.00 |
| 9 | −2.36106* | 0.10842 | 1.0000 | 0.00 |
| 10 | −1.45743* | 0.4 | 1.6707 | 19.30 |
| 11 | −3.01523* | 0.09617 | 1.0000 | 0.00 |
| 12 | 4.46206* | 0.806 | 1.5350 | 56.00 |
| 13 | −2.25657* | 0.09254 | 1.0000 | 0.00 |
| 14 | 1.39956* | 0.5 | 1.6707 | 19.30 |
| 15 | 0.84932* | 0.70386 | 1.0000 | 0.00 |
| 16 | 0 | 0.5 | 1.5163 | 64.14 |
| 17 | 0 | 0.40527 | 1.0000 | 0.00 |
| | | 6.322 | | |

Surface No.: 1

| r | K | | |
|---|---|---|---|
| 2.043E+01 | −3.720E+01 | | |
| c2 | c4 | c6 | c8 |
| 0.000E+00 | 2.529E−01 | −2.576E−01 | 3.238E−01 |
| c10 | c12 | c14 | c16 |
| −2.854E−01 | 1.571E−01 | −4.413E−02 | 3.729E−03 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 2

| r | K | | |
|---|---|---|---|
| 2.174E+00 | 2.881E+00 | | |
| c2 | c4 | c6 | c8 |
| 0.000E+00 | 3.986E−01 | −4.234E−01 | 6.896E−01 |
| c10 | c12 | c14 | c16 |
| 1.589E+00 | −8.423E+00 | 1.491E+01 | −9.395E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 6

| r | K | | |
|---|---|---|---|
| 1.413E+01 | 0.000E+00 | | |
| c2 | c4 | c6 | c8 |
| 0.000E+00 | −1.882E−02 | 5.889E−02 | −3.591E−01 |
| c10 | c12 | c14 | c16 |
| 3.481E−01 | 0.000E+00 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 7

| r | K | | |
|---|---|---|---|
| −3.479E+00 | 0.000E+00 | | |
| c2 | c4 | c6 | c8 |
| 0.000E+00 | −1.237E−01 | 1.004E−01 | −1.353E−01 |
| c10 | c12 | c14 | c16 |
| 1.528E−01 | −1.116E−01 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 8

| r | K | | |
|---|---|---|---|
| 5.019E+00 | 0.000E+00 | | |
| c2 | c4 | c6 | c8 |
| 0.000E+00 | −1.041E−01 | 7.392E−02 | −4.589E−02 |
| c10 | c12 | c14 | c16 |
| 2.910E−02 | −7.769E−03 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 9

| r | K | | |
|---|---|---|---|
| −2.361E+00 | 0.000E+00 | | |
| c2 | c4 | c6 | c8 |
| 0.000E+00 | 6.988E−02 | −2.514E−01 | 1.444E−01 |
| c10 | c12 | c14 | c16 |
| −2.270E−02 | 0.000E+00 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 10

| r | K | | |
|---|---|---|---|
| −1.457E+00 | 0.000E+00 | | |
| c2 | c4 | c6 | c8 |
| 0.000E+00 | 3.440E−01 | −2.882E−01 | 1.646E−01 |
| c10 | c12 | c14 | c16 |
| −4.447E−02 | 5.285E−03 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 11

| r | K | | |
|---|---|---|---|
| −3.015E+00 | 0.000E+00 | | |
| c2 | c4 | c6 | c8 |
| 0.000E+00 | 1.192E−01 | −2.425E−02 | −2.703E−03 |
| c10 | c12 | c14 | c16 |
| 2.280E−03 | −3.770E−04 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 12

| r | K | | |
|---|---|---|---|
| 4.462E+00 | 0.000E+00 | | |
| c2 | c4 | c6 | c8 |
| 0.000E+00 | 5.337E−02 | −3.987E−02 | 9.609E−03 |
| c10 | c12 | c14 | c16 |
| −1.542E−03 | 0.000E+00 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 13

| r | K | | |
|---|---|---|---|
| −2.257E+00 | 0.000E+00 | | |
| c2 | c4 | c6 | c8 |
| 0.000E+00 | 1.803E−01 | −5.202E−02 | 7.194E−03 |
| c10 | c12 | c14 | c16 |
| −4.363E−04 | 0.000E+00 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 14

| r | K | | |
|---|---|---|---|
| 1.400E+00 | −9.383E−01 | | |
| c2 | c4 | c6 | c8 |
| 0.000E+00 | −1.840E−01 | 3.242E−02 | −4.277E−03 |
| c10 | c12 | c14 | c16 |
| 3.236E−04 | 0.000E+00 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 15

| r | K | | |
|---|---|---|---|
| 8.493E−01 | −2.768E+00 | | |
| c2 | c4 | c6 | c8 |
| 0.000E+00 | −9.817E−02 | 3.212E−02 | −7.344E−03 |
| c10 | c12 | c14 | c16 |
| 1.047E−03 | −8.681E−05 | 3.146E−06 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

### Numerical Example 2

UNIT: mm
SURFACE DATA

| Surface No. | r | d | nd | νd |
|---|---|---|---|---|
| 1 | −3.12933* | 0.203 | 1.5961 | 61.64 |
| 2 | −2.46111* | 0.100 | 1.0000 | 0.00 |
| 3 | −5.85522* | 0.200 | 1.6442 | 56.02 |
| 4 | 1.22174* | 0.263 | 1.0000 | 0.00 |
| 5 | 1.07617* | 0.350 | 1.7120 | 29.57 |
| 6 | 2.49540* | 0.150 | 1.0000 | 0.00 |
| 7 | 0.00 | 0.050 | 1.5500 | 60.00 |
| 8 | 0.00 | 0.026 | 1.0000 | 0.00 |
| 9p | 0.00 | 0.111 | 1.0000 | 0.00 |
| 10 | 2.51112* | 0.584 | 1.5578 | 64.10 |
| 11 | −1.66109* | 0.338 | 1.0000 | 0.00 |
| 12 | −1.74430* | 0.200 | 1.7552 | 27.58 |
| 13 | −11.45362* | 0.121 | 1.0000 | 0.00 |
| 14 | 4.03661* | 0.619 | 1.7440 | 44.85 |
| 15 | −2.15498* | 0.203 | 1.0000 | 0.00 |
| 16 | −2.56069* | 0.210 | 1.6707 | 19.30 |
| 17 | −2.13956* | 0.100 | 1.0000 | 0.00 |
| 18 | 2.61353* | 0.648 | 1.7517 | 31.31 |
| 19 | 1.12931* | 0.300 | 1.0000 | 0.00 |
| 20 | 0 | 0.200 | 1.5163 | 64.14 |
| 21 | 0 | 0.050 | 1.0000 | 0.00 |
| | | 5.025 | | |

Surface No.: 1

| r | K | | |
|---|---|---|---|
| −3.129E+00 | 0.000E+00 | | |
| c2 | c4 | c6 | c8 |
| 0.00E+00 | 2.040E−01 | −6.400E−02 | 8.006E−03 |
| c10 | c12 | c14 | c16 |
| 0.000E+00 | 0.000E+00 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 2

| r | K | | |
|---|---|---|---|
| −2.461E+00 | 0.000E+00 | | |
| c2 | c4 | c6 | c8 |
| 0.000E+00 | 3.492E−01 | −9.119E−02 | 3.727E−02 |
| c10 | c12 | c14 | c16 |
| 0.000E+00 | 0.000E+00 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 3

| r | K | | |
|---|---|---|---|
| −5.855E+00 | 0.000E+00 | | |
| c2 | c4 | c6 | c8 |
| 0.000E+00 | 4.104E−01 | −2.525E−01 | 1.291E−01 |
| c10 | c12 | c14 | c16 |
| −1.888E−02 | 0.000E+00 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 4

| r | K | | |
|---|---|---|---|
| 1.222E+00 | 0.000E+00 | | |
| c2 | c4 | c6 | c8 |
| 0.000E+00 | 1.075E−01 | 2.500E−01 | −8.765E−01 |
| c10 | c12 | c14 | c16 |
| 4.742E−01 | 0.000E+00 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 5

| r | K | | |
|---|---|---|---|
| 1.076E+00 | 0.000E+00 | | |
| c2 | c4 | c6 | c8 |
| 0.000E+00 | −1.619E−01 | 4.089E−01 | −8.744E−01 |
| c10 | c12 | c14 | c16 |
| 0.000E+00 | 0.000E+00 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 6

| r | K | | |
|---|---|---|---|
| 2.495E+00 | 0.000E+00 | | |
| c2 | c4 | c6 | c8 |
| 0.000E+00 | 1.138E−01 | 3.661E−01 | −9.423E−01 |
| c10 | c12 | c14 | c16 |
| 0.000E+00 | 0.000E+00 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 10

| r | K | | |
|---|---|---|---|
| 2.511E+00 | 0.000E+00 | | |
| c2 | c4 | c6 | c8 |
| 0.000E+00 | 3.939E−02 | −2.868E−02 | 1.168E−01 |
| c10 | c12 | c14 | c16 |
| −1.362E−01 | 0.000E+00 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 11

| r | K | | |
|---|---|---|---|
| −1.661E+00 | 0.000E+00 | | |
| c2 | c4 | c6 | c8 |
| 0.000E+00 | −2.546E−02 | −2.263E−01 | 1.459E−01 |
| c10 | c12 | c14 | c16 |
| 7.087E−02 | 0.000E+00 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 12

| r | K | | |
|---|---|---|---|
| −1.744E+00 | 0.000E+00 | | |
| c2 | c4 | c6 | c8 |
| 0.000E+00 | 7.680E−02 | −5.087E−01 | 3.632E−01 |
| c10 | c12 | c14 | c16 |
| −3.299E−01 | 0.000E+00 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 13

| r | K | | |
|---|---|---|---|
| −1.145E+01 | 0.000E+00 | | |
| c2 | c4 | c6 | c8 |
| 0.000E+00 | −8.124E−02 | −7.837E−02 | 1.119E−01 |
| c10 | c12 | c14 | c16 |
| −3.242E−02 | 0.000E+00 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 14

| r | K | | |
|---|---|---|---|
| 4.037E+00 | 0.000E+00 | | |
| c2 | c4 | c6 | c8 |
| 0.000E+00 | −1.699E−01 | 5.468E−02 | −1.112E−02 |
| c10 | c12 | c14 | c16 |
| 0.000E+00 | 0.000E+00 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 15

| r | K | | |
|---|---|---|---|
| −2.155E+00 | 0.000E+00 | | |
| c2 | c4 | c6 | c8 |
| 0.000E+00 | −2.654E−02 | −3.716E−03 | 1.044E−02 |
| c10 | c12 | c14 | c16 |
| 0.000E+00 | 0.000E+00 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 16

| r | K | | |
|---|---|---|---|
| −2.561E+00 | 0.000E+00 | | |
| c2 | c4 | c6 | c8 |
| 0.000E+00 | 1.168E−01 | −6.714E−02 | 2.395E−03 |
| c10 | c12 | c14 | c16 |
| −8.466E−04 | 4.914E−04 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 17

| r | K | | |
|---|---|---|---|
| −2.140E+00 | −5.908E+00 | | |
| c2 | c4 | c6 | c8 |
| 0.000E+00 | 1.882E−01 | −1.428E−01 | 3.417E−02 |
| c10 | c12 | c14 | c16 |
| −2.929E−03 | 6.587E−05 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 18

| r | K | | |
|---|---|---|---|
| 2.614E+00 | −6.497E−01 | | |
| c2 | c4 | c6 | c8 |
| 0.000E+00 | −1.845E−01 | 4.121E−02 | −4.463E−03 |
| c10 | c12 | c14 | c16 |
| 2.394E−04 | −8.270E−06 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 19

| r | K | | |
|---|---|---|---|
| 1.129E+00 | −5.093E+00 | | |
| c2 | c4 | c6 | c8 |
| 0.000E+00 | −1.013E−01 | 3.301E−02 | −8.496E−03 |
| c10 | c12 | c14 | c16 |
| 1.154E−03 | −6.071E−05 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

### Numerical Example 3

UNIT: mm
SURFACE DATA

| Surface No. | r | d | nd | νd |
|---|---|---|---|---|
| 1 | 4.62241* | 0.505 | 1.5440 | 56.00 |
| 2 | 1.16439* | 0.871 | 1.0000 | 0.00 |
| 3 | 3.58946* | 0.196 | 1.6210 | 23.60 |
| 4 | 3.79590* | 0.194 | 1.0000 | 0.00 |
| 5 | 0 | 0.050 | 1.4500 | 60.00 |
| 6 | 0 | 0.050 | 1.0000 | 0.00 |
| 7p | 0 | 0.000 | 1.0000 | 0.00 |
| 8 | 4.07994* | 0.393 | 1.5910 | 27.20 |
| 9 | −28.07214* | 0.056 | 1.0000 | 0.00 |
| 10 | 3.55721* | 0.607 | 1.5440 | 56.00 |
| 11 | −3.29960* | 0.166 | 1.0000 | 0.00 |
| 12 | −3.78862* | 0.304 | 1.6980 | 16.30 |
| 13 | −66.94792* | 0.082 | 1.0000 | 0.00 |
| 14 | 1.80781* | 0.487 | 1.5440 | 56.00 |
| 15 | −86.60153* | 0.117 | 1.0000 | 0.00 |
| 16 | −17.20958* | 0.510 | 1.5440 | 56.00 |
| 17 | −4.07802* | 0.361 | 1.0000 | 0.00 |
| 18 | 10.06529* | 0.653 | 1.7050 | 14.00 |
| 19 | 2.73468* | 0.300 | 1.0000 | 0.00 |
| 20 | 0 | 0.210 | 1.5170 | 64.20 |
| 21 | 0 | 0.406 | 1.0000 | 0.00 |
| | | 6.518 | | |

Surface No.: 1

| r | K | | |
|---|---|---|---|
| 4.622E+00 | −1.094E+01 | | |
| c2 | c4 | c6 | c8 |
| 0.000E+00 | 4.215E−02 | −1.023E−02 | 4.898E−03 |
| c10 | c12 | c14 | c16 |
| −1.634E−03 | 3.390E−04 | −3.580E−05 | 9.917E−07 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| −8.670E−08 | 1.612E−09 | 0.000E+00 | 0.000E+00 |
| c17 | c19 | c21 | c23 |
| 0.000E+00 | 0.000E+00 | 0.000E+00 | 0.000E+00 |

Surface No.: 2

| r | K | | |
|---|---|---|---|
| 1.164E+00 | −4.771E+00 | | |
| c2 | c4 | c6 | c8 |
| 0.000E+00 | 3.864E−01 | −5.683E−01 | 1.274E+00 |
| c10 | c12 | c14 | c16 |
| −2.120E+00 | 2.297E+00 | −1.488E+00 | 5.070E−01 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| −6.558E−02 | −1.990E−03 | 0.000E+00 | 0.000E+00 |
| c17 | c19 | c21 | c23 |
| 0.000E+00 | 0.000E+00 | 0.000E+00 | 0.000E+00 |

Surface No.: 3

| r | K | | |
|---|---|---|---|
| 3.589E+00 | 0.000E+00 | | |
| c2 | c4 | c6 | c8 |
| 0.000E+00 | 7.095E−02 | 2.201E−01 | −3.076E−01 |
| c10 | c12 | c14 | c16 |
| 4.316E−01 | −1.245E+00 | 1.425E+00 | −3.317E−01 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| −2.810E−01 | 4.676E−02 | 0.000E+00 | 0.000E+00 |
| c17 | c19 | c21 | c23 |
| 0.000E+00 | 0.000E+00 | 0.000E+00 | 0.000E+00 |

Surface No.: 4

| r | K | | |
|---|---|---|---|
| 3.796E+00 | 2.258E+01 | | |
| c2 | c4 | c6 | c8 |
| 0.000E+00 | 1.852E−01 | 9.826E−01 | −5.310E+00 |
| c10 | c12 | c14 | c16 |
| 2.241E+01 | −5.727E+01 | 7.400E+01 | −2.945E+01 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| −2.289E+01 | 9.508E+00 | 0.000E+00 | 0.000E+00 |
| c17 | c19 | c21 | c23 |
| 0.000E+00 | 0.000E+00 | 0.000E+00 | 0.000E+00 |

Surface No.: 8

| r | K | | |
|---|---|---|---|
| 4.080E+00 | 0.000E+00 | | |
| c2 | c4 | c6 | c8 |
| 0.000E+00 | 5.772E−02 | 2.955E−02 | −1.819E+00 |
| c10 | c12 | c14 | c16 |
| 1.587E+00 | 1.089E+02 | −8.826E+02 | 3.011E+03 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| −4.901E+03 | 3.113E+03 | 0.000E+00 | 0.000E+00 |
| c17 | c19 | c21 | c23 |
| 0.000E+00 | 0.000E+00 | 0.000E+00 | 0.000E+00 |

Surface No.: 9

| r | K | | |
|---|---|---|---|
| −2.807E+01 | 0.000E+00 | | |
| c2 | c4 | c6 | c8 |
| 0.000E+00 | −1.353E−01 | 5.514E−01 | −6.524E+00 |
| c10 | c12 | c14 | c16 |
| 4.506E+01 | −1.942E+02 | 5.168E+02 | −8.298E+02 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 7.346E+02 | −2.752E+02 | 0.000E+00 | 0.000E+00 |
| c17 | c19 | c21 | c23 |
| 0.000E+00 | 0.000E+00 | 0.000E+00 | 0.000E+00 |

Surface No.: 10

| r | K | | |
|---|---|---|---|
| 3.557E+00 | 0.000E+00 | | |
| c2 | c4 | c6 | c8 |
| 0.000E+00 | −6.021E−02 | 7.631E−01 | −5.141E+00 |
| c10 | c12 | c14 | c16 |
| 2.515E+01 | −7.574E+01 | 1.400E+02 | −1.467E+02 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 6.841E+01 | −2.682E+00 | 0.000E+00 | 0.000E+00 |
| c17 | c19 | c21 | c23 |
| 0.000E+00 | 0.000E+00 | 0.000E+00 | 0.000E+00 |

Surface No.: 11

| r | K | | |
|---|---|---|---|
| −3.300E+00 | 2.124E+00 | | |
| c2 | c4 | c6 | c8 |
| 0.000E+00 | 6.577E−02 | −2.031E+00 | 8.361E+00 |
| c10 | c12 | c14 | c16 |
| −2.356E+01 | 4.524E+01 | −5.633E+01 | 4.365E+01 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| −1.892E+01 | 3.493E+00 | 0.000E+00 | 0.000E+00 |
| c17 | c19 | c21 | c23 |
| 0.000E+00 | 0.000E+00 | 0.000E+00 | 0.000E+00 |

Surface No.: 12

| r | K | | |
|---|---|---|---|
| −3.789E+00 | −1.778E+01 | | |
| c2 | c4 | c6 | c8 |
| 0.000E+00 | 2.889E−01 | −2.735E+00 | 7.864E+00 |
| c10 | c12 | c14 | c16 |
| −1.630E+01 | 2.519E+01 | −3.312E+01 | 3.676E+01 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| −2.728E+01 | 8.008E+00 | 0.000E+00 | 0.000E+00 |
| c17 | c19 | c21 | c23 |
| 0.000E+00 | 0.000E+00 | 0.000E+00 | 0.000E+00 |

Surface No.: 13

| r | K | | |
|---|---|---|---|
| −6.695E+01 | 3.747E+03 | | |
| c2 | c4 | c6 | c8 |
| 0.000E+00 | 1.637E−01 | −1.652E+00 | 4.805E+00 |
| c10 | c12 | c14 | c16 |
| −7.849E+00 | 8.144E+00 | −5.414E+00 | 2.235E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| −5.392E−01 | 6.301E−02 | 0.000E+00 | 0.000E+00 |
| c17 | c19 | c21 | c23 |
| 0.000E+00 | 0.000E+00 | 0.000E+00 | 0.000E+00 |

Surface No.: 14

| r | K | | |
|---|---|---|---|
| 1.808E+00 | −5.857E+00 | | |
| c2 | c4 | c6 | c8 |
| 0.000E+00 | −9.434E−02 | −3.679E−01 | 1.101E+00 |
| c10 | c12 | c14 | c16 |
| −1.441E+00 | 1.117E+00 | −5.504E−01 | 1.708E−01 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| −3.057E−02 | 2.373E−03 | 0.000E+00 | 0.000E+00 |
| c17 | c19 | c21 | c23 |
| 0.000E+00 | 0.000E+00 | 0.000E+00 | 0.000E+00 |

Surface No.: 15

| r | K | | |
|---|---|---|---|
| −8.660E+01 | 0.000E+00 | | |
| c2 | c4 | c6 | c8 |
| 0.000E+00 | −5.320E−03 | 7.848E−04 | −1.366E−03 |
| :10 | c12 | c14 | c16 |
| 0.000E+00 | 0.000E+00 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 16

| r | K | | |
|---|---|---|---|
| −1.721E+01 | 0.000E+00 | | |
| c2 | c4 | c6 | c8 |
| 0.000E+00 | −3.588E−03 | 1.122E−03 | −2.200E−04 |
| c10 | c12 | c14 | c16 |
| 3.945E−05 | 0.000E+00 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 17

| r | K | | |
|---|---|---|---|
| −4.078E+00 | 0.000E+00 | | |
| c2 | c4 | c6 | c8 |
| 0.000E+00 | 3.472E−03 | 1.991E−02 | −3.066E−01 |
| c10 | c12 | c14 | c16 |
| 5.026E−01 | −3.640E−01 | 1.386E−01 | −2.749E−02 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 2.357E−03 | −3.028E−05 | 0.000E+00 | 0.000E+00 |
| c17 | c19 | c21 | c23 |
| 0.000E+00 | 0.000E+00 | 0.000E+00 | 0.000E+00 |

Surface No.: 18

| r | K | | |
|---|---|---|---|
| 1.007E+01 | 0.000E+00 | | |
| c2 | c4 | c6 | c8 |
| 0.000E+00 | −1.195E−01 | 1.041E−01 | −6.028E−01 |
| c10 | c12 | c14 | c16 |
| 9.199E−01 | −6.713E−01 | 2.742E−01 | −6.433E−02 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 8.133E−03 | −4.319E−04 | 0.000E+00 | 0.000E+00 |
| c17 | c19 | c21 | c23 |
| 0.000E+00 | 0.000E+00 | 0.000E+00 | 0.000E+00 |

Surface No.: 19

| r | K | | |
|---|---|---|---|
| 2.735E+00 | 0.000E+00 | | |
| c2 | c4 | c6 | c8 |
| 0.000E+00 | −2.807E−02 | −1.628E−01 | 1.454E−01 |
| c10 | c12 | c14 | c16 |
| −6.325E−02 | 1.635E−02 | −2.650E−03 | 2.654E−04 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| −1.502E−05 | 3.634E−07 | 0.000E+00 | 0.000E+00 |
| c17 | c19 | c21 | c23 |
| 0.000E+00 | 0.000E+00 | 0.000E+00 | 0.000E+00 |

### Numerical Example 4

UNIT: mm
SURFACE DATA

| Surface No. | r | d | nd | νd |
|---|---|---|---|---|
| 1 | 4.85900* | 0.624 | 1.5440 | 56.00 |
| 2 | 2.08621* | 0.210 | 1.0000 | 0.00 |
| 3 | 2.13972* | 0.499 | 1.6980 | 16.30 |
| 4 | 1.50459* | 0.453 | 1.0000 | 0.00 |
| 5 | 1.97868* | 0.375 | 1.6210 | 23.60 |
| 6 | 2.92786* | 0.206 | 1.0000 | 0.00 |
| 7 | 0 | 0.050 | 1.6000 | 60.00 |
| 8 | 0 | 0.010 | 1.0000 | 0.00 |
| 9p | 0 | 0.124 | 1.0000 | 0.00 |
| 10 | −5.22737* | 0.374 | 1.5910 | 27.20 |
| 11 | −2.33079* | −0.041 | 1.0000 | 0.00 |
| 12 | 0 | 0.125 | 1.0000 | 0.00 |
| 13 | −14.67504* | 0.709 | 1.5440 | 56.00 |
| 14 | −1.64372* | 0.124 | 1.0000 | 0.00 |
| 15 | −5.65019* | 0.374 | 1.5910 | 27.20 |
| 16 | 6.52090* | 0.375 | 1.0000 | 0.00 |
| 17 | −4.43922* | 0.375 | 1.6980 | 16.30 |
| 18 | −5.67294* | 0.125 | 1.0000 | 0.00 |
| 19 | −15.04164* | 0.771 | 1.5440 | 56.00 |
| 20 | −2.38531* | 0.124 | 1.0000 | 0.00 |
| 21 | 2.79956* | 0.873 | 1.5440 | 56.00 |
| 22 | 2.95909* | 0.249 | 1.0000 | 0.00 |
| 23 | 9.65024* | 0.709 | 1.7050 | 14.00 |
| 24 | 3.94122* | 0.375 | 1.0000 | 0.00 |
| 25 | 0 | 0.263 | 1.5170 | 64.20 |
| 26 | 0 | 0.562 | 1.0000 | 0.00 |
| | | 9.017 | | |

Surface No.: 1

| r | K | | |
|---|---|---|---|
| 4.859E+00 | 0.000E+00 | | |
| c2 | c4 | c6 | c8 |
| 0.000E+00 | −6.227E−03 | 2.493E−03 | −3.644E−04 |
| c10 | c12 | c14 | c16 |
| 3.526E−05 | −1.608E−06 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 2

| r | K | | |
|---|---|---|---|
| 2.086E+00 | 0.000E+00 | | |
| c2 | c4 | c6 | c8 |
| 0.000E+00 | −6.316E−03 | −7.542E−03 | 4.006E−03 |
| c10 | c12 | c14 | c16 |
| −1.047E−03 | 0.000E+00 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 3

| r | K | | |
|---|---|---|---|
| 2.140E+00 | 0.000E+00 | | |
| c2 | c4 | c6 | c8 |
| 0.000E+00 | 3.886E−02 | −2.243E−02 | 6.149E−03 |
| c10 | c12 | c14 | c16 |
| −1.934E−03 | 1.036E−04 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 4

| r | K | | |
|---|---|---|---|
| 1.505E+00 | 0.000E+00 | | |
| c2 | c4 | c6 | c8 |
| 0.000E+00 | 4.751E−02 | −4.047E−02 | −9.320E−03 |
| c10 | c12 | c14 | c16 |
| −1.565E−03 | 0.000E+00 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 5

| r | K | | |
|---|---|---|---|
| 1.979E+00 | 0.000E+00 | | |
| c2 | c4 | c6 | c8 |
| 0.000E+00 | 6.045E−02 | 1.064E−02 | 0.000E+00 |
| c10 | c12 | c14 | c16 |
| 0.000E+00 | 0.000E+00 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 6

| r | K | | |
|---|---|---|---|
| 2.928E+00 | 0.000E+00 | | |
| c2 | c4 | c6 | c8 |
| 0.000E+00 | 9.618E−02 | 2.132E−01 | −4.475E−01 |
| c10 | c12 | c14 | c16 |
| 4.461E−01 | 0.000E+00 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| −5.153E−01 | 1.370E−01 | 0.000E+00 | 0.000E+00 |
| c17 | c19 | c21 | c23 |
| 0.000E+00 | 0.000E+00 | 0.000E+00 | 0.000E+00 |

Surface No.: 10

| r | K | | |
|---|---|---|---|
| −5.227E+00 | 0.000E+00 | | |
| c2 | c4 | c6 | c8 |
| 0.000E+00 | −9.373E−02 | −1.206E−01 | 0.000E+00 |
| c10 | c12 | c14 | c16 |
| 0.000E+00 | 0.000E+00 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 11

| r | K | | |
|---|---|---|---|
| −2.331E+00 | 0.000E+00 | | |
| c2 | c4 | c6 | c8 |
| 0.000E+00 | 1.214E−01 | −3.859E−01 | −7.057E−01 |
| c10 | c12 | c14 | c16 |
| 6.833E+00 | −2.239E+01 | 4.229E+01 | −4.745E+01 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 2.956E+01 | −7.917E+00 | 0.000E+00 | 0.000E+00 |
| c17 | c19 | c21 | c23 |
| 0.000E+00 | 0.000E+00 | 0.000E+00 | 0.000E+00 |

Surface No.: 13

| r | K | | |
|---|---|---|---|
| −1.468E+01 | 0.000E+00 | | |
| c2 | c4 | c6 | c8 |
| 0.000E+00 | 2.850E−01 | −5.328E−01 | 2.285E−01 |
| c10 | c12 | c14 | c16 |
| 2.743E+00 | −1.074E+01 | 2.034E+01 | −2.152E+01 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 1.204E+01 | −2.769E+00 | 0.000E+00 | 0.000E+00 |
| c17 | c19 | c21 | c23 |
| 0.000E+00 | 0.000E+00 | 0.000E+00 | 0.000E+00 |

Surface No.: 14

| r | K | | |
|---|---|---|---|
| −1.644E+00 | 0.000E+00 | | |
| c2 | c4 | c6 | c8 |
| 0.000E+00 | −3.244E−02 | −5.918E−04 | 0.000E+00 |
| c10 | c12 | c14 | c16 |
| 0.000E+00 | 0.000E+00 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 15

| r | K | | |
|---|---|---|---|
| −5.650E+00 | 0.000E+00 | | |
| c2 | c4 | c6 | c8 |
| 0.000E+00 | −3.474E−01 | 1.678E−01 | 0.000E+00 |
| c10 | c12 | c14 | c16 |
| 0.000E+00 | 0.000E+00 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 16

| r | K | | |
|---|---|---|---|
| 6.521E+00 | 0.000E+00 | | |
| c2 | c4 | c6 | c8 |
| 0.000E+00 | −2.731E−01 | −8.791E−04 | 4.790E−01 |
| c10 | c12 | c14 | c16 |
| −1.384E+00 | 2.289E+00 | −2.330E+00 | 1.447E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| −5.045E−01 | 7.627E−02 | 0.000E+00 | 0.000E+00 |
| c17 | c19 | c21 | c23 |
| 0.000E+00 | 0.000E+00 | 0.000E+00 | 0.000E+00 |

Surface No.: 17

| r | K | | |
|---|---|---|---|
| −4.439E+00 | 8.117E+00 | | |
| c2 | c4 | c6 | c8 |
| 0.000E+00 | −1.161E−02 | −9.041E−02 | 1.550E−01 |
| c10 | c12 | c14 | c16 |
| −4.175E−01 | 7.337E−01 | −8.049E−01 | 5.330E−01 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| −1.985E−01 | 3.220E−02 | 0.000E+00 | 0.000E+00 |
| c17 | c19 | c21 | c23 |
| 0.000E+00 | 0.000E+00 | 0.000E+00 | 0.000E+00 |

Surface No.: 18

| r | K | | |
|---|---|---|---|
| −5.673E+00 | −1.000E+00 | | |
| c2 | c4 | c6 | c8 |
| 0.000E+00 | −2.988E−02 | 1.366E−02 | −2.708E−02 |
| c10 | c12 | c14 | c16 |
| 3.504E−02 | −3.003E−02 | 1.507E−02 | −4.360E−03 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 7.191E−04 | −5.681E−05 | 0.000E+00 | 0.000E+00 |
| c17 | c19 | c21 | c23 |
| 0.000E+00 | 0.000E+00 | 0.000E+00 | 0.000E+00 |

Surface No.: 19

| r | K | | |
|---|---|---|---|
| −1.504E+01 | 0.000E+00 | | |
| c2 | c4 | c6 | c8 |
| 0.000E+00 | 5.764E−02 | −1.460E−02 | 0.000E+00 |
| c10 | c12 | c14 | c16 |
| 0.000E+00 | 0.000E+00 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 20

| r | K | | |
|---|---|---|---|
| −2.385E+00 | 0.000E+00 | | |
| c2 | c4 | c6 | c8 |
| 0.000E+00 | 6.652E−02 | 8.957E−03 | −6.675E−03 |
| c10 | c12 | c14 | c16 |
| 7.810E−04 | 0.000E+00 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 21

| r | K | | |
|---|---|---|---|
| 2.800E+00 | 0.000E+00 | | |
| c2 | c4 | c6 | c8 |
| 0.000E+00 | −5.008E−02 | 3.870E−03 | −3.647E−04 |
| c10 | c12 | c14 | c16 |
| 0.000E+00 | 0.000E+00 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | 19 | c21 | c23 |
| 0.000E+00 | 0.000E+00 | 0.000E+00 | 0.000E+00 |

Surface No.: 22

| r | K | | |
|---|---|---|---|
| 2.959E+00 | 0.000E+00 | | |
| c2 | c4 | c6 | c8 |
| 0.000E+00 | −4.494E−02 | 2.227E−03 | −1.301E−04 |
| c10 | c12 | c14 | c16 |
| 4.814E−05 | −6.927E−06 | 0.000E+00 | 0.000E+00 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 23

| r | K | | |
|---|---|---|---|
| 9.650E+00 | 0.000E+00 | | |
| c2 | c4 | c6 | c8 |
| 0.000E+00 | −1.129E−02 | −3.053E−03 | 1.354E−03 |
| c10 | c12 | c14 | c16 |
| −1.919E−04 | 1.103E−05 | −2.754E−07 | 6.580E−09 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

Surface No.: 24

| r | K | | |
|---|---|---|---|
| 3.941E+00 | 0.000E+00 | | |
| c2 | c4 | c6 | c8 |
| 0.000E+00 | −3.513E−02 | 5.108E−03 | −5.067E−04 |
| c10 | c12 | c14 | c16 |
| 2.256E−05 | −2.416E−07 | −8.185E−10 | −6.125E−10 |
| c1 | c3 | c5 | c7 |
| 0.000E+00 | 0.000E+00 | 0.000E+00 | 0.000E+00 |
| c9 | c11 | c13 | c15 |
| 0.000E+00 | 0.000E+00 | 0.000E+00 | 0.000E+00 |
| c18 | c20 | c22 | c24 |
| 0.000E+00 | 0.000E+00 | 0.000E+00 | 0.000E+00 |
| c17 | c19 | c21 | c23 |
| 0.000E+00 | 0.000E+00 | 0.000E+00 | 0.000E+00 |

### Numerical Example 5

UNIT: mm
SURFACE DATA

| Surface No. | r | d | nd | νd |
|---|---|---|---|---|
| 1 | −3.16261* | 0.189 | 1.5316 | 55.84 |
| 2 | −2.89272* | 0.100 | | |
| 3 | −8.32719* | 0.150 | 1.5316 | 55.84 |
| 4 | 1.15440* | 0.238 | | |
| 5 | 1.22569* | 0.231 | 1.5316 | 55.84 |
| 6 | 5.50176* | 0.140 | | |
| 7 | −6.76664* | 0.173 | 1.6707 | 19.30 |
| 8 | −7.43975* | 0.115 | | |
| 9p | 0 | 0.010 | | |
| 10 | 0 | 0.045 | 1.5000 | 60.00 |
| 11 | 0 | 0.060 | | |
| 12 | 3.15445* | 0.351 | 1.5316 | 55.84 |
| 13 | −1.65116* | 0.126 | | |
| 14 | −3.67553* | 0.250 | 1.5316 | 55.84 |
| 15 | −2.19986* | 0.329 | | |
| 16 | −1.50024* | 0.178 | 1.6707 | 19.30 |
| 17 | −4.30263* | 0.100 | | |
| 18 | 5.93044* | 0.596 | 1.5316 | 55.84 |
| 19 | −1.92195* | 0.212 | | |
| 20 | −2.74816* | 0.168 | 1.6707 | 19.30 |
| 21 | −4.13329* | 0.100 | | |
| 22 | 2.54853* | 0.605 | 1.5316 | 55.84 |
| 23 | 1.14335* | 0.331 | | |
| 24 | 0 | 0.200 | 1.5163 | 64.14 |
| 25 | 0 | 0.100 | | |
| | | 5.096 | | |

Surface No.: 1

| r | K | | |
|---|---|---|---|
| −3.16E+00 | 0.00E+00 | | |
| c2 | c4 | c6 | c8 |
| 0.00E+00 | 2.04E−01 | −6.29E−02 | 8.72E−03 |
| c10 | c12 | c14 | c16 |
| 0.00E+00 | 0.00E+00 | 0.00E+00 | 0.00E+00 |
| c1 | c3 | c5 | c7 |
| 0.00E+00 | 0.00E+00 | 0.00E+00 | 0.00E+00 |
| c9 | c11 | c13 | c15 |
| 0.00E+00 | 0.00E+00 | 0.00E+00 | 0.00E+00 |
| c18 | c20 | c22 | c24 |
| 0.00E+00 | 0.00E+00 | 0.00E+00 | 0.00E+00 |
| c17 | c19 | c21 | c23 |
| 0.00E+00 | 0.00E+00 | 0.00E+00 | 0.00E+00 |

Surface No.: 2

| r | K | | |
|---|---|---|---|
| −2.89E+00 | 0.00E+00 | | |
| c2 | c4 | c6 | c8 |
| 0.00E+00 | 3.43E−01 | −8.96E−02 | 4.43E−02 |
| c10 | c12 | c14 | c16 |
| 0.00E+00 | 0.00E+00 | 0.00E+00 | 0.00E+00 |
| c1 | c3 | c5 | c7 |
| 0.00E+00 | 0.00E+00 | 0.00E+00 | 0.00E+00 |
| c9 | c11 | c13 | c15 |
| 0.00E+00 | 0.00E+00 | 0.00E+00 | 0.00E+00 |
| c18 | c20 | c22 | c24 |
| 0.00E+00 | 0.00E+00 | 0.00E+00 | 0.00E+00 |
| c17 | c19 | c21 | c23 |
| 0.00E+00 | 0.00E+00 | 0.00E+00 | 0.00E+00 |

Surface No.: 3

| r | K | | |
|---|---|---|---|
| −8.33E+00 | 0.00E+00 | | |
| c2 | c4 | c6 | c8 |
| 0.00E+00 | 4.16E−01 | −2.60E−01 | 1.41E−01 |
| c10 | c12 | c14 | c16 |
| −1.42E−02 | 0.00E+00 | 0.00E+00 | 0.00E+00 |
| c1 | c3 | c5 | c7 |
| 0.00E+00 | 0.00E+00 | 0.00E+00 | 0.00E+00 |
| c9 | c11 | c13 | c15 |
| 0.00E+00 | 0.00E+00 | 0.00E+00 | 0.00E+00 |
| c18 | c20 | c22 | c24 |
| 0.00E+00 | 0.00E+00 | 0.00E+00 | 0.00E+00 |
| c17 | c19 | c21 | c23 |
| 0.00E+00 | 0.00E+00 | 0.00E+00 | 0.00E+00 |

Surface No.: 4

| r | K | | |
|---|---|---|---|
| 1.15E+00 | 0.00E+00 | | |
| c2 | c4 | c6 | c8 |
| 0.00E+00 | 9.95E−02 | 2.17E−01 | −9.24E−01 |
| c10 | c12 | c14 | c16 |
| 4.44E−01 | 0.00E+00 | 0.00E+00 | 0.00E+00 |
| c1 | c3 | c5 | c7 |
| 0.00E+00 | 0.00E+00 | 0.00E+00 | 0.00E+00 |
| c9 | c11 | c13 | c15 |
| 0.00E+00 | 0.00E+00 | 0.00E+00 | 0.00E+00 |
| c18 | c20 | c22 | c24 |
| 0.00E+00 | 0.00E+00 | 0.00E+00 | 0.00E+00 |
| c17 | c19 | c21 | c23 |
| 0.00E+00 | 0.00E+00 | 0.00E+00 | 0.00E+00 |

Surface No.: 5

| r | K | | |
|---|---|---|---|
| 1.23E+00 | 0.00E+00 | | |
| c2 | c4 | c6 | c8 |
| 0.00E+00 | −1.87E−01 | 5.00E−01 | −7.72E−01 |
| c10 | c12 | c14 | c16 |
| 0.00E+00 | 0.00E+00 | 0.00E+00 | 0.00E+00 |
| c1 | c3 | c5 | c7 |
| 0.00E+00 | 0.00E+00 | 0.00E+00 | 0.00E+00 |
| c9 | c11 | c13 | c15 |
| 0.00E+00 | 0.00E+00 | 0.00E+00 | 0.00E+00 |
| c18 | c20 | c22 | c24 |
| 0.00E+00 | 0.00E+00 | 0.00E+00 | 0.00E+00 |
| c17 | c19 | c21 | c23 |
| 0.00E+00 | 0.00E+00 | 0.00E+00 | 0.00E+00 |

Surface No.: 6

| r | K | | |
|---|---|---|---|
| 5.50E+00 | 0.00E+00 | | |
| c2 | c4 | c6 | c8 |
| 0.00E+00 | 1.41E−01 | 3.38E−01 | −3.43E−01 |
| c10 | c12 | c14 | c16 |
| 0.00E+00 | 0.00E+00 | 0.00E+00 | 0.00E+00 |
| c1 | c3 | c5 | c7 |
| 0.00E+00 | 0.00E+00 | 0.00E+00 | 0.00E+00 |
| c9 | c11 | c13 | c15 |
| 0.00E+00 | 0.00E+00 | 0.00E+00 | 0.00E+00 |
| c18 | c20 | c22 | c24 |
| 0.00E+00 | 0.00E+00 | 0.00E+00 | 0.00E+00 |
| c17 | c19 | c21 | c23 |
| 0.00E+00 | 0.00E+00 | 0.00E+00 | 0.00E+00 |

Surface No.: 7

| r | K | | |
|---|---|---|---|
| −6.77E+00 | 0.00E+00 | | |
| c2 | c4 | c6 | c8 |
| 0.00E+00 | 2.96E−02 | −1.94E−01 | −1.07E−01 |
| c10 | c12 | c14 | c16 |
| 4.78E−01 | −7.45E−12 | 4.55E−13 | −3.26E−16 |
| c1 | c3 | c5 | c7 |
| 0.00E+00 | 0.00E+00 | 0.00E+00 | 0.00E+00 |
| c9 | c11 | c13 | c15 |
| 0.00E+00 | 0.00E+00 | 0.00E+00 | 0.00E+00 |
| c18 | c20 | c22 | c24 |
| 0.00E+00 | 0.00E+00 | 0.00E+00 | 0.00E+00 |
| c17 | c19 | c21 | c23 |
| 0.00E+00 | 0.00E+00 | 0.00E+00 | 0.00E+00 |

Surface No.: 8

| r | K | | |
|---|---|---|---|
| −7.44E+00 | 0.00E+00 | | |
| c2 | c4 | c6 | c8 |
| 0.00E+00 | 6.66E−02 | −1.50E−01 | 2.25E−02 |
| c10 | c12 | c14 | c16 |
| 7.76E−01 | 7.95E−14 | 3.73E−15 | 9.34E−17 |
| c1 | c3 | c5 | c7 |
| 0.00E+00 | 0.00E+00 | 0.00E+00 | 0.00E+00 |
| c9 | c11 | c13 | c15 |
| 0.00E+00 | 0.00E+00 | 0.00E+00 | 0.00E+00 |
| c18 | c20 | c22 | c24 |
| 0.00E+00 | 0.00E+00 | 0.00E+00 | 0.00E+00 |
| c17 | c19 | c21 | c23 |
| 0.00E+00 | 0.00E+00 | 0.00E+00 | 0.00E+00 |

Surface No.: 12

| r | K | | |
|---|---|---|---|
| 3.15E+00 | 0.00E+00 | | |
| c2 | c4 | c6 | c8 |
| 0.00E+00 | 8.03E−02 | −1.83E−01 | 3.14E−01 |
| c10 | c12 | c14 | c16 |
| −3.23E−01 | 0.00E+00 | 0.00E+00 | 0.00E+00 |
| c1 | c3 | c5 | c7 |
| 0.00E+00 | 0.00E+00 | 0.00E+00 | 0.00E+00 |
| c9 | c11 | c13 | c15 |
| 0.00E+00 | 0.00E+00 | 0.00E+00 | 0.00E+00 |
| c18 | c20 | c22 | c24 |
| 0.00E+00 | 0.00E+00 | 0.00E+00 | 0.00E+00 |
| c17 | c19 | c21 | c23 |
| 0.00E+00 | 0.00E+00 | 0.00E+00 | 0.00E+00 |

Surface No.: 13

| r | K | | |
|---|---|---|---|
| −1.65E+00 | 0.00E+00 | | |
| c2 | c4 | c6 | c8 |
| 0.00E+00 | −3.51E−02 | −1.04E−01 | 1.95E−01 |
| c10 | c12 | c14 | c16 |
| 0.00E+00 | 0.00E+00 | 0.00E+00 | 0.00E+00 |
| c1 | c3 | c5 | c7 |
| 0.00E+00 | 0.00E+00 | 0.00E+00 | 0.00E+00 |
| c9 | c11 | c13 | c15 |
| 0.00E+00 | 0.00E+00 | 0.00E+00 | 0.00E+00 |
| c18 | c20 | c22 | c24 |
| 0.00E+00 | 0.00E+00 | 0.00E+00 | 0.00E+00 |
| c17 | c19 | c21 | c23 |
| 0.00E+00 | 0.00E+00 | 0.00E+00 | 0.00E+00 |

Surface No.: 14

| r | K | | |
|---|---|---|---|
| −3.68E+00 | 0.00E+00 | | |
| c2 | c4 | c6 | c8 |
| 0.00E+00 | −1.51E−03 | −4.05E−02 | 2.70E−01 |
| c10 | c12 | c14 | c16 |
| 0.00E+00 | 0.00E+00 | 0.00E+00 | 0.00E+00 |
| c1 | c3 | c5 | c7 |
| 0.00E+00 | 0.00E+00 | 0.00E+00 | 0.00E+00 |
| c9 | c11 | c13 | c15 |
| 0.00E+00 | 0.00E+00 | 0.00E+00 | 0.00E+00 |
| c18 | c20 | c22 | c24 |
| 0.00E+00 | 0.00E+00 | 0.00E+00 | 0.00E+00 |
| c17 | c19 | c21 | c23 |
| 0.00E+00 | 0.00E+00 | 0.00E+00 | 0.00E+00 |

Surface No.: 15

| r | K | | |
|---|---|---|---|
| −2.20E+00 | 0.00E+00 | | |
| c2 | c4 | c6 | c8 |
| 0.00E+00 | −7.91E−02 | −2.24E−01 | 1.75E−01 |
| c10 | c12 | c14 | c16 |
| 6.01E−02 | 0.00E+00 | 0.00E+00 | 0.00E+00 |
| c1 | c3 | c5 | c7 |
| 0.00E+00 | 0.00E+00 | 0.00E+00 | 0.00E+00 |
| c9 | c11 | c13 | c15 |
| 0.00E+00 | 0.00E+00 | 0.00E+00 | 0.00E+00 |
| c18 | c20 | c22 | c24 |
| 0.00E+00 | 0.00E+00 | 0.00E+00 | 0.00E+00 |
| c17 | c19 | c21 | c23 |
| 0.00E+00 | 0.00E+00 | 0.00E+00 | 0.00E+00 |

Surface No.: 16

| r | K | | |
|---|---|---|---|
| −1.50E+00 | 0.00E+00 | | |
| c2 | c4 | c6 | c8 |
| 0.00E+00 | −2.09E−02 | −5.17E−01 | 2.69E−01 |
| c10 | c12 | c14 | c16 |
| −3.56E−01 | 0.00E+00 | 0.00E+00 | 0.00E+00 |
| c1 | c3 | c5 | c7 |
| 0.00E+00 | 0.00E+00 | 0.00E+00 | 0.00E+00 |
| c9 | c11 | c13 | c15 |
| 0.00E+00 | 0.00E+00 | 0.00E+00 | 0.00E+00 |
| c18 | c20 | c22 | c24 |
| 0.00E+00 | 0.00E+00 | 0.00E+00 | 0.00E+00 |
| c17 | c19 | c21 | c23 |
| 0.00E+00 | 0.00E+00 | 0.00E+00 | 0.00E+00 |

Surface No.: 17

| r | K | | |
|---|---|---|---|
| −4.30E+00 | 0.00E+00 | | |
| c2 | c4 | c6 | c8 |
| 0.00E+00 | −7.86E−02 | −7.10E−02 | 1.31E−01 |
| c10 | c12 | c14 | c16 |
| −1.20E−02 | 0.00E+00 | 0.00E+00 | 0.00E+00 |
| c1 | c3 | c5 | c7 |
| 0.00E+00 | 0.00E+00 | 0.00E+00 | 0.00E+00 |
| c9 | c11 | c13 | c15 |
| 0.00E+00 | 0.00E+00 | 0.00E+00 | 0.00E+00 |
| c18 | c20 | c22 | c24 |
| 0.00E+00 | 0.00E+00 | 0.00E+00 | 0.00E+00 |
| c17 | c19 | c21 | c23 |
| 0.00E+00 | 0.00E+00 | 0.00E+00 | 0.00E+00 |

Surface No.: 18

| r | K | | |
|---|---|---|---|
| 5.93E+00 | 0.00E+00 | | |
| c2 | c4 | c6 | c8 |
| 0.00E+00 | −1.98E−01 | 7.09E−02 | −1.77E−02 |
| c10 | c12 | c14 | c16 |
| 0.00E+00 | 0.00E+00 | 0.00E+00 | 0.00E+00 |
| c1 | c3 | c5 | c7 |
| 0.00E+00 | 0.00E+00 | 0.00E+00 | 0.00E+00 |
| c9 | c11 | c13 | c15 |
| 0.00E+00 | 0.00E+00 | 0.00E+00 | 0.00E+00 |
| c18 | c20 | c22 | c24 |
| 0.00E+00 | 0.00E+00 | 0.00E+00 | 0.00E+00 |
| c17 | c19 | c21 | c23 |
| 0.00E+00 | 0.00E+00 | 0.00E+00 | 0.00E+00 |

Surface No.: 19

| r | K | | |
|---|---|---|---|
| −1.92E+00 | 0.00E+00 | | |
| c2 | c4 | c6 | c8 |
| 0.00E+00 | −2.53E−02 | −6.38E−03 | 1.25E−02 |
| c10 | c12 | c14 | c16 |
| 0.00E+00 | 0.00E+00 | 0.00E+00 | 0.00E+00 |
| c1 | c3 | c5 | c7 |
| 0.00E+00 | 0.00E+00 | 0.00E+00 | 0.00E+00 |
| c9 | c11 | c13 | c15 |
| 0.00E+00 | 0.00E+00 | 0.00E+00 | 0.00E+00 |
| c18 | c20 | c22 | c24 |
| 0.00E+00 | 0.00E+00 | 0.00E+00 | 0.00E+00 |
| c17 | c19 | c21 | c23 |
| 0.00E+00 | 0.00E+00 | 0.00E+00 | 0.00E+00 |

Surface No.: 20

| r | K | | |
|---|---|---|---|
| −2.75E+00 | 0.00E+00 | | |
| c2 | c4 | c6 | c8 |
| 0.00E+00 | 1.10E−01 | −6.74E−02 | −3.08E−03 |
| c10 | c12 | c14 | c16 |
| −3.97E−04 | 1.04E−03 | 0.00E+00 | 0.00E+00 |
| c1 | c3 | c5 | c7 |
| 0.00E+00 | 0.00E+00 | 0.00E+00 | 0.00E+00 |
| c9 | c11 | c13 | c15 |
| 0.00E+00 | 0.00E+00 | 0.00E+00 | 0.00E+00 |
| c18 | c20 | c22 | c24 |
| 0.00E+00 | 0.00E+00 | 0.00E+00 | 0.00E+00 |
| c17 | c19 | c21 | c23 |
| 0.00E+00 | 0.00E+00 | 0.00E+00 | 0.00E+00 |

Surface No.: 21

| r | K | | |
|---|---|---|---|
| −4.13E+00 | −5.88E+00 | | |
| c2 | c4 | c6 | c8 |
| 0.00E+00 | 2.01E−01 | −1.42E−01 | 3.41E−02 |
| c10 | c12 | c14 | c16 |
| −3.02E−03 | 3.43E−05 | 0.00E+00 | 0.00E+00 |
| c1 | c3 | c5 | c7 |
| 0.00E+00 | 0.00E+00 | 0.00E+00 | 0.00E+00 |
| c9 | c11 | c13 | c15 |
| 0.00E+00 | 0.00E+00 | 0.00E+00 | 0.00E+00 |
| c18 | c20 | c22 | c24 |
| 0.00E+00 | 0.00E+00 | 0.00E+00 | 0.00E+00 |
| c17 | c19 | c21 | c23 |
| 0.00E+00 | 0.00E+00 | 0.00E+00 | 0.00E+00 |

Surface No.: 22

| r | K | | |
|---|---|---|---|
| 2.55E+00 | −7.10E−01 | | |
| c2 | c4 | c6 | c8 |
| 0.00E+00 | −1.85E−01 | 4.13E−02 | −4.43E−03 |
| c10 | c12 | c14 | c16 |
| 2.48E−04 | −6.21E−06 | 0.00E+00 | 0.00E+00 |
| c1 | c3 | c5 | c7 |
| 0.00E+00 | 0.00E+00 | 0.00E+00 | 0.00E+00 |
| c9 | c11 | c13 | c15 |
| 0.00E+00 | 0.00E+00 | 0.00E+00 | 0.00E+00 |
| c18 | c20 | c22 | c24 |
| 0.00E+00 | 0.00E+00 | 0.00E+00 | 0.00E+00 |
| c17 | c19 | c21 | c23 |
| 0.00E+00 | 0.00E+00 | 0.00E+00 | 0.00E+00 |

Surface No.: 23

| r | K | | |
|---|---|---|---|
| 1.14E+00 | −3.92E+00 | | |
| c2 | c4 | c6 | c8 |
| 0.00E+00 | −8.59E−02 | 3.03E−02 | −8.26E−03 |
| c10 | c12 | c14 | c16 |
| 1.15E−03 | −6.26E−05 | 0.00E+00 | 0.00E+00 |
| c1 | c3 | c5 | c7 |
| 0.00E+00 | 0.00E+00 | 0.00E+00 | 0.00E+00 |
| c9 | c11 | c13 | c15 |
| 0.00E+00 | 0.00E+00 | 0.00E+00 | 0.00E+00 |
| c18 | c20 | c22 | c24 |
| 0.00E+00 | 0.00E+00 | 0.00E+00 | 0.00E+00 |
| c17 | c19 | c21 | c23 |
| 0.00E+00 | 0.00E+00 | 0.00E+00 | 0.00E+00 |

Table 1 summarizes the values of the above inequalities in respective examples.

TABLE 1

| | NUMERICAL EXAMPLE | | | | |
|---|---|---|---|---|---|
| INEQUALITY | 1 | 2 | 3 | 4 | 5 |
| (1)\|n1 − nA\| | 0.0020 | 0.0070 | 0.0060 | 0.0085 | 0.0010 |
| (2)θ | 57.3 | 63.6 | 52.4 | 58.4 | 60.0 |
| (3)d | 0.050 | 0.050 | 0.050 | 0.030 | 0.045 |
| (4)d × \|n1 − nA\| × sinθ | 0.00008 | 0.00031 | 0.00024 | 0.00022 | 0.00004 |
| (5)\|n1 − n2\| | 0.0020 | 0.0080 | 0.0050 | 0.0070 | 0.0010 |
| (6)\|n1 − n3\| | 0.0020 | 0.0060 | 0.0070 | 0.0100 | 0.0030 |
| (7)n1 | 1.500 | 1.550 | 1.450 | 1.600 | 1.500 |
| (8)S/f | 0.022 | 0.067 | 0.026 | 0.003 | 0.005 |
| (9)f1/f | −1.99 | −4.39 | −3.11 | −3.11 | −3.11 |
| (10)ImgH/L | 0.52 | 0.70 | 0.48 | 0.43 | 1.36 |
| (11)nf | 1.671 | 1.752 | 1.705 | 1.705 | 1.705 |
| (12)PL | 6.000 | 6.000 | 6.000 | 75.000 | 75.000 |
| (13)Tm | 12.50 | 12.50 | 25.00 | 12.50 | 12.50 |
| n2 | 1.502 | 1.558 | 1.455 | 1.607 | 1.499 |
| n3 | 1.502 | 1.556 | 1.457 | 1.610 | 1.503 |
| nA | 1.5020 | 1.5570 | 1.4560 | 1.6085 | 1.5010 |
| S | 0.05 | 0.11 | 0.05 | 0.01 | 0.01 |
| f | 2.30 | 1.65 | 1.92 | 3.05 | 2.04 |
| f1 | −4.58 | −7.25 | −7.25 | −7.27 | −7.27 |
| ImgH | 3.30 | 3.54 | 3.11 | 3.88 | 6.91 |
| L | 6.322 | 5.025 | 6.518 | 9.017 | 5.096 |

### Image Pickup Apparatus

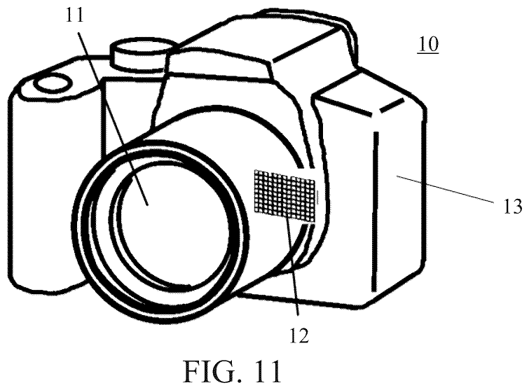

Referring now to FIG. 11, a description will be given of an image pickup apparatus having any one of the optical systems according to the above examples. FIG. 11 is a schematic diagram of the image pickup apparatus (digital still camera) 10 according to this embodiment. The image pickup apparatus 10 includes a camera body 13, a lens unit (imaging optical system) 11, and an image sensor (photoelectric conversion element) 12. The lens unit 11 may be integrated with the camera body 13, or may be attachable to and detachable from the camera body 13.

The lens unit 11 includes an optical system L0 according to any one of Examples 1 to 5. The image sensor 12 is a photoelectric conversion element such as a CMOS sensor or CCD sensor, and photoelectrically converts the image formed by the lens unit 11 to output image data. The optical system according to each example is applicable not only to the digital still camera illustrated in FIG. 11, but also to a variety of optical apparatuses such as film-based cameras, video cameras, and telescopes.

The configuration according to each example suppresses light beam separation and degradation of image quality, even when the light beam incident angle of the optical filter is large. Thus, each example can provide an optical system and an image pickup apparatus, each of which has high optical performance.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-020512, filed on Feb. 12, 2025, which is hereby incorporated by reference herein in its entirety.

What is claimed is:

1. An optical system comprising:
a lens A; and
an optical filter made from resin,
wherein the following inequality is satisfied:
$$n A = ( n 2 + n 3 ) / 2$$
$$0. \leq \leq \vert n 1 - nA \vert \leq 0.020$$
where n1 is a refractive index of the optical filter for d-line in a first direction parallel to an optical axis of the lens A, n2 is a refractive index of the optical filter for the d-line in a second direction orthogonal to the first direction, n3 is a refractive index of the optical filter for the d-line in a third direction orthogonal to both the first direction and the second directions.

2. The optical system according to claim 1, wherein the following inequality is satisfied:
$$15 \leq θ < 90$$
where θ (°) is an angle at which a principal ray of outermost off-axis light of the optical system is incident on the optical filter.

3. The optical system according to claim 1, wherein the following inequality is satisfied:
$$0. < d \leq 0.100$$
where d (mm) is a thickness of the optical filter.

4. The optical system according to claim 1, wherein the following inequality is satisfied:
$$0. \leq d \times \vert n 1 - nA \vert \times sin θ \leq 0.0010$$
where θ (°) is an angle at which a principal ray of outermost off-axis light of the optical system is incident on the optical filter, and d (mm) is a thickness of the optical filter.

5. The optical system according to claim 1, wherein the following inequalities are satisfied:
$$0. \leq \vert n 1 - n 2 \vert \leq 0 \text{.016}$$
$$0. \leq \vert n 1 - n 3 \vert \leq 0.016 .$$

6. The optical system according to claim 1, wherein the following inequality is satisfied:
$$1.4 \leq n 1 \leq 1.7 .$$

7. The optical system according to claim 1, wherein the lens A is made from resin.

8. The optical system according to claim 1, wherein the lens A is made from resin and disposed closest to an object among a plurality of lenses in the optical system.

9. The optical system according to claim 1, wherein the lens A is made from resin and disposed on an object side of the optical filter.

10. The optical system according to claim 1, wherein the lens A is made from resin with positive refractive power disposed on an image side of the optical filter.

11. The optical system according to claim 1, further comprising an aperture stop,
wherein the following inequality is satisfied:
$$0. < S / f \leq 1.$$
where f is a focal length of the optical system, and S is a distance between the optical filter and the aperture stop in an optical axis direction.

12. The optical system according to claim 1, wherein the lens A is disposed closest to an image plane of the optical system, and
wherein an object-side lens surface of the lens A has an inflection point and is convex near the optical axis and concave at a periphery.

13. The optical system according to claim 1, wherein the lens A is disposed closest to an image plane of the optical system, and
wherein an image-side lens surface of the lens A has an inflection point and is concave near the optical axis and convex at a periphery.

14. The optical system according to claim 1, wherein the optical system consists of, in order from an object side to an image side, a first lens unit with negative refractive power, the optical filter, an aperture stop, and a second lens unit with positive refractive power.

15. The optical system according to claim 1, wherein the optical system consists of, in order from an object side to an image side, a first lens unit with negative refractive power, an aperture stop, the optical filter, and a second lens unit with positive refractive power.

16. The optical system according to claim 14, wherein the following inequality is satisfied:
$$- 6.00 \leq f 1 / f < 0.00$$
where f1 is a focal length of the first lens unit, and f is a focal length of the optical system.

17. The optical system according to claim 1, wherein the following inequality is satisfied:
$$0. 25 \leq ImgH / L \leq 2.$$
where ImgH is a maximum image height of the optical system, and L is an overall length of the optical system.

18. The optical system according to claim 1, wherein the lens A is disposed closest to an image plane in the optical system, and
wherein the following inequality is satisfied:
$$1.55 \leq nf \leq 1.9$$
where nf is a refractive index of the lens A for d-line.

19. The optical system according to claim 1, wherein the following inequality is satisfied:
$$0 < PL \leq 100$$
where PL (10⁻¹²/Pa) is a photoelastic coefficient of the optical filter.

20. An image pickup apparatus comprising:
an optical system; and
an image sensor,
wherein the optical system includes:
a lens A, and
an optical filter made from resin, and
wherein the following inequality is satisfied:
$$n A = ( n 2 + n 3 ) / 2$$
$$0. \leq \vert n 1 - nA \vert \leq 0.020$$
where n1 is a refractive index of the optical filter for d-line in a first direction parallel to an optical axis of the lens A, n2 is a refractive index of the optical filter for the d-line in a second direction orthogonal to the first direction, n3 is a refractive index of the optical filter for the d-line in a third direction orthogonal to both the first direction and the second directions.
